(19) United States
(12) Patent Application Publication
(10) Pub. No.: US 2014/0320039 A1
(43) Pub. Date: Oct. 30, 2014

(54) Backlight control module and backlight control method

(71) Applicant: Wistron Corporation, New Taipei City (TW)

(72) Inventors: Meng-Chao Kao, New Taipei City (TW); Tzu-Chiang Shen, New Taipei City (TW); Hui-Chen Lin, New Taipei City (TW)

(73) Assignee: Wistron Corporation, New Taipei City (TW)

(21) Appl. No.: 13/949,236

(22) Filed: Jul. 24, 2013

(30) Foreign Application Priority Data
Apr. 29, 2013 (TW) 102115249

(51) Int. Cl. H05B 37/02

(52) U.S. Cl. CPC H05B 37/02
USPC 315/250

(57) ABSTRACT

A backlight control module comprises a backlight computing unit configuring a frequency of at least one PWM signal according to a frequency of a frame, when at least one area frame of at least one display area is used for displaying the frame; a timing control unit configuring at least one starting time instant of a period of the at least one PWM signal according to at least one starting time instant of the at least one area frame, respectively; and a PWM unit generating the at least one PWM signal, and configuring at least one width of at least one on-period of the period of the at least one PWM signal according to at least one image data of the at least one area frame, respectively, wherein the at least one on-period is located at an end of the period of the at least one PWM signal, respectively.

### BACKGROUND OF THE INVENTION

1. Field of the Invention

The present disclosure relates to a backlight control module and a backlight control method, and more particularly, to a backlight control module and a backlight control method capable of performing local dimming controls of at least one display area of a display device.

2. Description of the Prior Art

As a local dimming control technology becomes mature, more and more display devices (e.g., liquid-crystal display (LCD) monitors, LCD televisions, LED LCD monitors, LED LCD televisions, etc.) equip with the local dimming control technology, to reduce power consumption, decrease light leakage and increase dynamic contrast when the display devices do not need to be full bright or full dark. In detail, the local dimming control technology first divides a display device into multiple display areas and then adjusts a backlight of each display area according to brightness of an area frame of each display area. For example, a weaker backlight can be used for a display area with a darker area frame to reduce the power consumption and decrease the light leakage in the display area, and a stronger backlight can be used for a display area with a brighter area frame to represent image details more clearly to increase the dynamic contrast. Thus, a user can acquire better viewing experience though the local dimming control technology.

### SUMMARY OF THE INVENTION

The present disclosure discloses a backlight control module, for generating at least one pulse-width modulation (PWM) signal to perform local dimming controls on at least one display area of a display device. The backlight control module includes a backlight computing unit, for configuring a frequency of the at least one PWM signal according to a frequency of a frame when at least one area frame of the at least one display area is used for displaying the frame; a timing control unit, for configuring at least one starting time instant of a period of the at least one PWM signal according to at least one starting time instant of the at least one area frame, respectively; and a PWM unit, coupled to the backlight computing unit and the timing control unit for generating the at least one PWM signal and configuring at least one width of at least one on-period of the period of the at least one PWM signal according to at least one image data of the at least one area frame, respectively, wherein the at least one on-period is located at an end of the period of the at least one PWM signal, respectively.

The present disclosure further discloses a backlight control method for generating at least one pulse-width modulation (PWM) signal to perform local dimming controls on at least one display area of a display device. The backlight control method includes configuring a frequency of the at least one PWM signal according to a frequency of a frame, when at least one area frame of the at least one display area is used for displaying the frame; configuring at least one starting timing instant of a period of the at least one PWM signal according to at least one starting time instant of the at least one area frame, respectively; and generating the at least one PWM signal and configuring at least one width of at least one on-period of the period of the at least one PWM signal according to at least one image data of the at least one area frame, respectively, wherein the at least one on-period is located at an end of the period of the at least one PWM signal, respectively.

The present disclosure further discloses a liquid-crystal display device, including a display panel, for displaying a frame; and a backlight control module, coupled to the display panel for generating at least one pulse-width modulation (PWM) signal to perform local dimming controls on at least one display area of the display panel, the backlight control module including: a backlight computing unit, for configuring a frequency of the at least one PWM according to a frequency of the frame, when at least one area frame of the at least one display area is used for displaying the frame; a timing control unit, for configuring at least one starting time instant of a period of the at least one PWM signal according to at least one starting time instant of the at least one area frame, respectively; and a PWM unit, coupled to the backlight computing unit and the timing control unit for generating the at least one PWM signal and configuring at least one width of at least one on-period of the period of the at least one PWM signal according to at least one image data of the at least one area frame, respectively, wherein the at least one on-period is located at an end of the period of the at least one PWM signal, respectively.

The present disclosure further discloses a backlight control module, for generating a first pulse-width modulation (PWM) signal and a second PWM signal to perform local dimming controls on a first display area and a second display area of a display device. The backlight control module includes a backlight computing unit, for configuring a frequency of the first PWM signal and a frequency of the second PWM signal according to a frequency of a frame when a first area frame of the first display area and a second area frame of the second display area are used for displaying parts of the frame; a timing control unit, for configuring a starting time instant of a period of the first PWM signal and a starting time instant of a period of the second PWM signal according to a starting time instant of the first area frame and a starting time instant of the second area frame, respectively; and a PWM unit, coupled to the backlight computing unit and the timing control unit for generating the first PWM signal and the second PWM signal and configuring a width of an on-period of the period of the first PWM signal and a width of an on-period of the period of the second PWM signal according to an image data of the first area frame and an image data of the second area frame, respectively, wherein the on-period of the first PWM signal and the on-period of the second PWM signal are located at an end of the period of the first PWM signal and an end of the period of the second PWM signal, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a backlight control module according to an embodiment of the present disclosure.

FIG. 2 is a schematic diagram of partitions of a display area of a display device according to an embodiment of the present disclosure.

FIG. 3 is a schematic diagram of a PWM signal determined according to area frames of the display device shown in FIG. 2.

FIG. 4 is a flowchart of a process according to an embodiment of the present disclosure.

### DETAILED DESCRIPTION

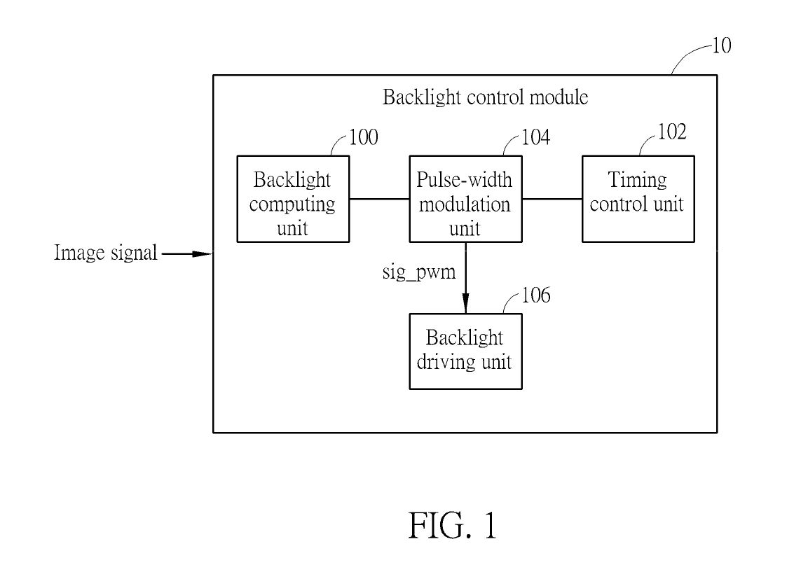

Please refer to FIG. 1, which is a schematic diagram of a backlight control module 10 according to an embodiment of the present disclosure. The backlight control module 10 includes a backlight computing unit 100, a timing control unit 102 and a pulse-width modulation (PWM) unit 104. The backlight control module 10 is utilized in a display device (e.g. a liquid-crystal display (LCD) monitor, a LCD television, a LED LCD monitor, a LED LCD television, etc.) for generating at least one PWM signal to perform local dimming controls on at least one display area of the display device, i.e. for controlling an enabling time of a backlight of the at least one display area. In detail, The backlight computing unit 100 is used for configuring a frequency of at least on PWM signal sig_pwm according to a frequency of a frame (i.e., a refreshing frequency) when at least one area frame of the at least one display area is used for displaying the frame. The timing control unit 102 is utilized for configuring at least one starting time instant of a period of the at least one PWM signal sig_pwm according to at least one starting time instant of the at least one area frame of the at least one display area, respectively. The PWM unit 104 is coupled to the backlight computing unit 100 and the timing control unit 102 for generating the at least one PWM signal sig_pwm and configuring at least one width of at least one on-period of the period of the at least one PWM signal sig_pwm according to at least one image data (e.g., at least one brightness of the at least one image data) of the at least one area frame of the at least one display area, respectively. The at least one on-period is located at an end of the period of the at least one PWM signal sig_pwm, respectively. In addition, the backlight control module 10 may further includes a backlight driving unit 106 coupled to the PWM unit 104 for configuring at least one enabling time of at least one backlight of the at least one display area according to the at least one starting time instant of the period of the at least one PWM signal sig_pwm and the at least one width of the at least one on-period, respectively. In brief, the backlight control module 10 not only synchronizes with the frequency and the starting time instant of the PWM signal with the frequency and the starting time instant of the frame to be displayed, but also configures the width of the on-period according to the image data of the area frame and configures the on-period at the end of the PWM signal. Thus, via operations of the backlight control module 10, the display device not only can adjust the enabling time of the backlight of each display area according to the width of the on-period of the PWM signal to reduce power consumption, decrease leakage light and increase dynamic contrast, but can also eliminate motion blur generated due to transitions of liquid-crystal.

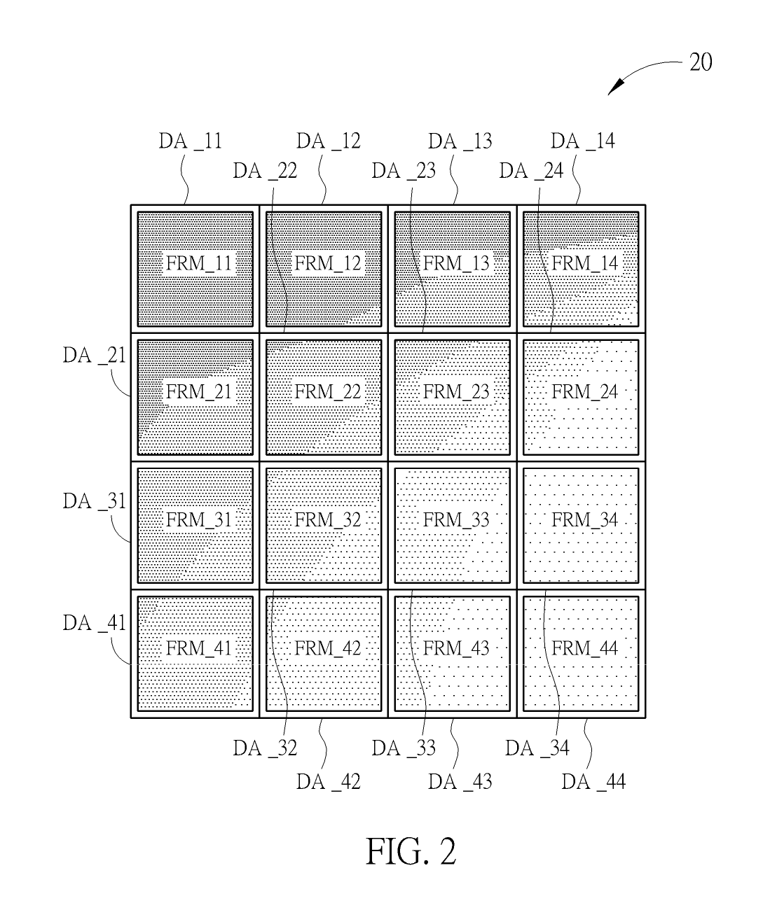

Please refer to FIG. 2, which is a schematic diagram of partitions of a display area of a display device 20. As shown in FIG. 2, in order to implement the local dimming controls, the display device 20 is divided into 16 display areas DA_11-DA_44. The display areas DA_11-DA_44 are used for displaying 16 area frames FRM_11-FRM_44 generated by dividing a frame, respectively, and image data of the area frames FRM_11-FRM_44 have various brightness. For example, the area frames FRM_11-FRM_14 have the lowest brightness, the area frames FRM_21-FRM_24 have the second lowest brightness, the area frames FRM_31-FRM_34 have the third lowest brightness, and other area frames have higher brightness. The abovementioned the lowest brightness, the second lowest brightness and the third lowest brightness are utilized for illustrating that the brightness of area frames are not exactly the same. The brightness of the image data of the area frames belongs to the same brightness level (i.e. the lowest brightness, the second lowest brightness or the third lowest brightness) may be slightly different from each other. Please note that, FIG. 2 is only utilized as an example for illustrating a method according to which the display area of the display device (or a panel thereof) is divided. In fact, the shape of the display area is not limited to squares, and can be rectangles or arbitrary geometric shapes. The number of the display areas is also not limited to 16, and can be adjusted according to system requirements or design considerations. The backlight control module 10 therefore can configure the enabling times of the backlights of the display areas DA_11-DA_44 according to the brightness of the image data of the area frames FRM_11-FRM_44, respectively.

In addition, the display device 20 is used for illustrating the concept of the present invention in the above description, those skilled in the art may accordingly observe appropriate alternations or modifications. For example, the display device includes a display panel for displaying the frame, generally. When the display device further includes the backlight control module of the present disclosure, the backlight control module can control the local dimming of the display panel via coupling the backlight control module of the present disclosure (e.g., the backlight control module 10) to the display panel. That is, the display area of the display device 20 can be substituted by a display area of the display panel of the display device 20. The operation methods can be known by referring to the above and are not narrated herein for brevity.

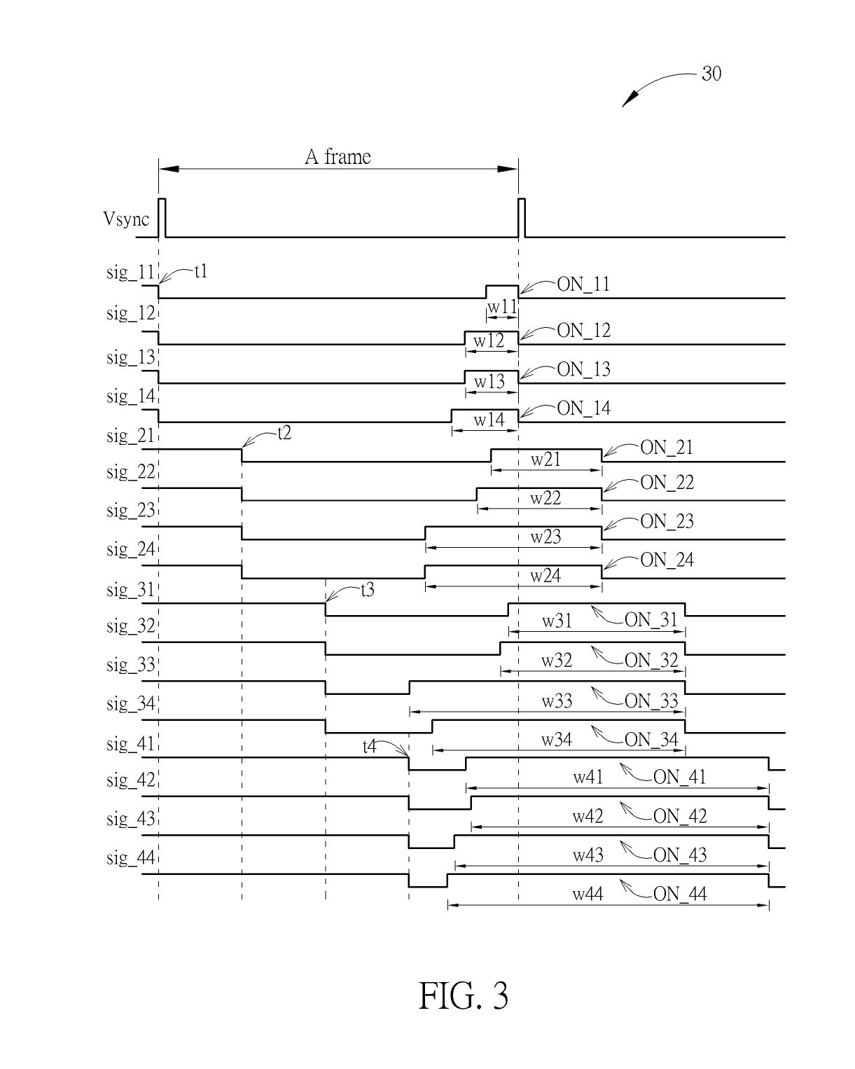

Please refer to FIG. 3, which is a schematic diagram of PWM signals acquired according to the area frames of the display device 20 and is utilized for illustrating relationships between a vertical synchronization signal Vsync and PWM signals sig_11-sig_44. The vertical synchronization signal Vsync is utilized for triggering the display device 20 to read a frame. In detail, time instants t1-t4 are starting time instants of the PWM signals sig_11-sig_14, the PWM signals sig_21-sig_24, the PWM signals sig_31-sig_34 and the PWM signals sig_41-sig_44, respectively. On-periods ON_11-ON_44 are on-periods of the PWM signals sig_11-sig_44, respectively, and widths (i.e. the pulse widths) of periods of the on-periods ON_11-ON_44 are w11-w44, respectively. Those skilled in the art should know that the period is a sum of lengths of the on-period and the off-period. The PWM signals sig_11-sig_44 are corresponding to the display area DA_11-DA_44, respectively, for configuring the enabling times and the stating time instants of the local dimming. As shown in FIG. 3, the display device 20 starts to read a frame per Tf unit time (e.g., ms), i.e., the length of the frame is the Tf unit time. That is, the frequency of the frame (i.e., refreshing frequency) is 1/TF. According to the concept of the present invention, the backlight computing unit 100 configures all the frequencies of the PWM signals sig_11-sig_44 to 1/TF, i.e., the PWM signals sig_11-sig_44 are generated per Tf unit time (i.e. the width of the PWM signals sig_11-sig_44 are Tf unit time), for synchronizing the frequency of the PWM signals with the frequency of the frame. Next, the timing control unit 102 configures the starting time instants t1-t4 of the PWM signals sig_11-sig_44 according to the starting time instants of the area frames FRM_11-FRM_44 of the display area DA_11-DA_44, respectively.

Taking the display area DA_21 as an example, when the starting time instant of the area frame FRM_21 is not considered, the starting time instant of the period of the PWM signal sig_21 can be the starting time instant t1 or an arbitrary time instant. When the display device 20 begins reading the frame according to the vertical synchronization signal Vsync, the area frames located on different display areas would have different starting time instants. For example, the different starting time instants may be caused by delays which are caused by different locations of the display areas. Thus, after the timing control unit 102 or other computing unit estimates or calculates that the starting time instant of the area frame FRM_21 is the time instant t2, the timing control unit 102 adjusts the starting time instant of the period of the PWM signal sig_21 to the time instant t2, accordingly, to completely synchronize (i.e., synchronize in the time and the frequency) the PWM signal sig_21 with the area frame FRM_21. Similarly, under the condition that the time instant t2, the time instant t3 and the time instant t4 are the starting time instants of the area frames FRM_22-FRM_24, the area frames FRM_31-FRM_34 and the area frames FRM_41-FRM_44, the timing control unit 102 can adjust the starting time instants of the periods of the PWM signals sig_22-sig_24, the PWM signals sig_31-sig_34 and the PWM signals sig_41-sig_44 to the time instants t2, the time instant t3 and the time instant t4, respectively. As a result, the PWM signals sig_22-sig_24, the PWM signals sig_31-sig_34 and the PWM signals sig_41-sig_44 are synchronized with the area frames FRM_22-FRM_24, the area frames FRM_31-FRM_34 and the area frames FRM_41-FRM_44, respectively.

Please note that, methods of determining the starting time instants of the area frames FRM_11-FRM_44 are not limited. For example, the starting time instants of the area frame FRM_11-FRM_44 can be determined according to starting times of transitions of liquid-crystal components of the display areas DA_11-DA_44, respectively. For example, in the display area DA_21, a set of liquid-crystal components may start transition after delaying a specific time (e.g., delaying (t2-t1) unit time) due to the position of the display area DA_21, to display the area frame FRM_21, when the display device 20 begins reading the frame according to the vertical synchronization signal Vsync. The timing control unit 102 can determine the starting time instant t2 of the area frame FRM_22 according to the starting time of the transition of the set of liquid-crystal components in the display area DA_21. For example, the set of the liquid-crystal components is the liquid-crystal components located on a horizontal scan line of the display area DA_21. Preferably, the horizontal scan line is located at a middle position of the display area DA_21, to reduce errors between the starting time instant t2 of the period of the PWM signal sig_21 and other scan lines of the display area DA_21. Noticeably, when the starting time instants of the area frame FRM_11-FRM_44 (e.g., the delays needed by liquid-crystal transitions) increase from top to bottom according to the positions of the display areas DA_11-DA_44 (e.g., when the display device 20 is a direct back-lit LED LCD display device), a better result can be obtained by determining the starting time instant of the display area according to the horizontal scan line located at the middle position of the display area. Similarly, the timing control unit 102 can determine the starting time instants t1-t4 according to the above principles which is not narrated herein for brevity. As a result, the motion blur caused by the differences between the starting time instants of the area frames can be reduced.

The PWM unit 104 also needs to decide the widths w11-w44 and positions of the on-period ON_11-ON_44 in addition to determining the starting time instants of the periods of the PWM signals sig_11-sig_44, when generating the PWM signals sig_11-sig_44. For example, the PWM unit 104 determines the width w21 of the on-period ON_21 of the PWM signal sig_21 according to a brightness level (e.g., a grey-level value) of image data of the area frame FRM_21. In one example, the PWM unit 104 determines that the width w21 of the on-period ON_21 is proportional to the grey-level value of the area frame FRM_21. That is, the width w21 is broader when the image data of the area frame FRM_21 has a higher grey-level value; and the width w21 is narrower when the image data of the area frame FRM_21 has a lower grey-level value. In addition, since the liquid-crystal needs a specific time to reach a steady state (i.e. finishing the transition) after starting the transition starts, the PWM unit 104 can configure the on-period ON_21 at an end of the period of the PWM signal sig_21 (i.e. configuring the off-period at a front end of the period) after determining the width w21 of the on-period ON_21, to maximize an overlapped part between the on-period ON_21 and the period where the liquid-crystal stays in the steady state. On the other hand, there are various methods for determining the grey-level value of the image data of the area frame FRM_21. For example, the grey-level value of the area frame FRM_21 can be the maximum grey-level value among the image data of the area frame FRM_21. When the grey-level value of the area frame FRM_21 is within 0-255 (e.g., 8 bits are used for displaying the area frame FRM_21 in the display device 20), the PWM unit 104 can determine the width w21 of the on-period ON_21 as

$$( \frac{20}{255} \times Tf )$$

if the grey-level value of the area frame FRM_21 is 20. Similarly, the PWM unit 104 can determine the widths of the on-periods of the other PWM signals according to the above description.

Please note that, the PWM unit 104 can determine the widths of the on-periods of the PWM signals such that the backlight driving unit 106 can configure the enabling times of the backlights of the display areas DA_11-DA_44 according to the widths of the on-periods. In the condition that the period of the PWM signal is fixed (which is proportional to the 1/Tf), the width of the on-period is corresponding to the width of the off-period. That is, the PWM unit 104 can determine the width of the off-period of the PWM signal for the backlight driving unit 106 to configure the enabling time of the backlight of the display area. Similarly, the width of the on-period is also corresponding to a duty-cycle of the PWM signal. The PWM unit 104 can determine the duty-cycle of the PWM signal for the backlight driving unit 106 to configure the enabling time of the backlight of the display area.

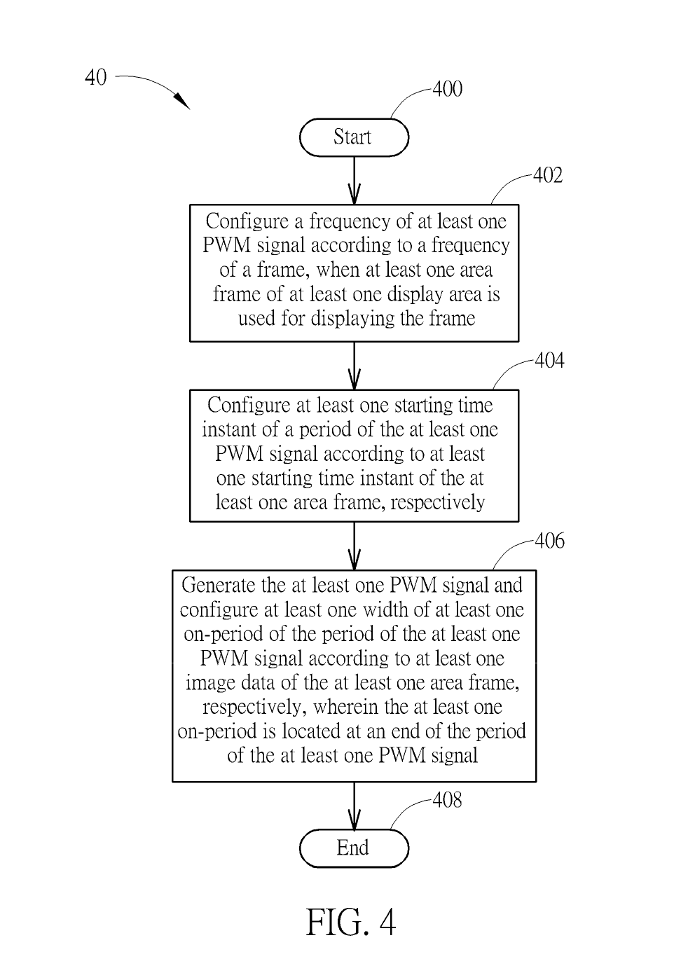

According to the above, the operation of the backlight control module 10 shown in FIG. 1 can be summarized to a process 40 shown in FIG. 4. The process 40 includes the following steps:

Step 400: Start.

Step 402: Configure a frequency of at least one PWM signal according to a frequency of a frame, when at least one area frame of at least one display area is used for displaying the frame.

Step 404: Configure at least one starting time instant of a period of the at least one PWM signal according to at least one starting time instant of the at least one area frame, respectively.

Step 406: Generate the at least one PWM signal and configure at least one width of at least one on-period of the period of the at least one PWM signal according to at least one image data of the at least one area frame, respectively, wherein the at least one on-period is located at an end of the period of the at least one PWM signal.

Step 408: End.

To sum up, the above embodiments provide a backlight control module and a backlight control method capable of not only adjusting the enabling times of the area frame of each display area according to the width of the on-period of the PWM signal to reduce the power consumption, decrease the light leakage and increase the dynamic contrast, but also decreasing the additional power consumption and eliminating the motion blur caused due to the transitions of the liquid-crystal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight control module, for generating at least one pulse-width modulation (PWM) signal to perform local dimming controls on at least one display area of a display device, the backlight control module comprising:
a backlight computing unit, for configuring a frequency of the at least one PWM signal according to a frequency of a frame, when at least one area frame of the at least one display area is used for displaying the frame;
a timing control unit, for configuring at least one starting time instant of a period of the at least one PWM signal according to at least one starting time instant of the at least one area frame, respectively; and
a PWM unit, coupled to the backlight computing unit and the timing control unit for generating the at least one PWM signal and configuring at least one width of at least one on-period of the period of the at least one PWM signal according to at least one image data of the at least one area frame, respectively, wherein the at least one on-period is located at an end of the period of the at least one PWM signal, respectively.

2. The backlight control module of claim 1, further comprising:
a backlight driving unit, coupled to the PWM unit, the backlight driving unit for configuring at least one enabling time of at least one backlight of the at least one display area according to the at least one starting time instant of the period of the at least one PWM signal and the at least one width of the at least one on-period, respectively.

3. The backlight control module of claim 1, wherein the frequency of the frame and the frequency of the at least one PWM signal are the same.

4. The backlight control module of claim 1, wherein the at least one starting time instant of the period of the at least one PWM signal is the same as the at least one starting timing instant of the at least one area frame, respectively.

5. The backlight control module of claim 1, wherein the at least one starting timing instant of the period of the at least one area frame relates to at least one transition start time of at least one set of liquid-crystal components in the at least one display area, respectively.

6. The backlight control module of claim 5, wherein the at least one set of liquid-crystal components is located at at least one horizontal scan line of the at least one display area, respectively.

7. The backlight control module of claim 6, wherein the at least one horizontal scan line of the at least one display area is located at least one middle position of the at least one display area, respectively.

8. The backlight control module of claim 1, wherein the at least one starting timing instant of the at least one area frame relates to at least one height of the at least one display area, respectively, and an area frame of a display area with a higher height has an earlier starting time instant.

9. The backlight control module of claim 1, wherein the at least one width of the at least one on-period of the period of the at least one PWM signal is proportional to at least one grey-level value of the at least one image data of the at least one area frame, respectively.

10. The backlight module of claim 9, wherein the at least one grey-level value of the at least one image data is at least one maximum grey-level value of the at least one image data, respectively.

11. A backlight control method for generating at least one pulse-width modulation (PWM) signal to perform local dimming controls on at least one display area of a display device, the backlight control method comprising:
configuring a frequency of the at least one PWM signal according to a frequency of a frame, when at least one area frame of the at least one display area is used for displaying the frame;
configuring at least one starting timing instant of a period of the at least one PWM signal according to at least one starting time instant of the at least one area frame, respectively; and
generating the at least one PWM signal and configuring at least one width of at least one on-period of the period of the at least one PWM signal according to at least one image data of the at least one area frame, respectively, wherein the at least one on-period is located at an end of the period of the at least one PWM signal, respectively.

12. The backlight control method of claim 11, further comprising:
configuring at least one enabling time of at least one backlight of the at least one display area according to the at least one starting time instant of the period of the at least one PWM signal and the at least one width of the at least one on-period, respectively.

13. The backlight control method of claim 11, wherein the at least one starting time instant of the period of the at least one area frame relates to at least one transition start time instant of at least one set of liquid-crystal components in the at least one display area, respectively.

14. The backlight control method of claim 13, wherein the at least one set of liquid-crystal components is located at at least one horizontal scan line of the at least one display area, respectively.

15. The backlight control method of claim 14, wherein the at least one horizontal scan line of the at least one display area is located at at least one middle position of the at least one display area, respectively.

16. The backlight control method of claim 11, wherein the at least one starting time instant of the at least one area frame relates to at least one height of the at least one display area, respectively, and an area frame of a display area with a higher height has an earlier starting time instant.

17. A backlight control module, for generating a first pulse-width modulation (PWM) signal and a second PWM signal to perform local dimming controls on a first display area and a second display area of a display device, the backlight control module comprising:
a backlight computing unit, for configuring a frequency of the first PWM signal and a frequency of the second PWM signal according to a frequency of a frame, when a first area frame of the first display area and a second area frame of the second display area are used for displaying parts of the frame;
a timing control unit, for configuring a starting time instant of a period of the first PWM signal and a starting time instant of a period of the second PWM signal according to a starting time instant of the first area frame and a starting time instant of the second area frame, respectively; and
a PWM unit, coupled to the backlight computing unit and the timing control unit for generating the first PWM signal and the second PWM signal and configuring a width of an on-period of the period of the first PWM signal and a width of an on-period of the period of the second PWM signal according to an image data of the first area frame and an image data of the second area frame, respectively, wherein the on-period of the first PWM signal and the on-period of the second PWM signal are located at an end of the period of the first PWM signal and an end of the period of the second PWM signal, respectively.

18. The backlight control module of claim 17, further comprising:
a backlight driving unit, coupled to the PWM unit for configuring an enabling time of a backlight of the first display area according to the starting time instant and the width of the on-period of the period of the first PWM signal and configuring an enable time of a backlight in the second display area according to the starting time instant and the width of the on-period of the period of the second PWM signal.

19. The backlight control module of claim 17, wherein the width of the on-period of the period of the first PWM signal is proportional to a first grey-level value of the image data of the first area frame, and the width of the on-period of the period of the second PWM signal is proportional to a second grey-level value of the image data of the second area frame.

20. The backlight control module of claim 19, wherein the width of the on-period of the period of the first PWM signal is greater than the width of the on-period of the period of the second PWM signal, when the first grey-level value of the image data of the first area frame is greater than the second grey-level value of the image data of the second area frame.
